(19) United States
(12) Patent Application Publication
(10) Pub. No.: US 2022/0097112 A1
(43) Pub. Date: Mar. 31, 2022

(54) ROLLING WITH ALLOWANCE FOR FREQUENCY RESPONSE

(71) Applicant: Primetals Technologies Germany GmbH, Erlangen (DE)

(72) Inventors: Matthias Dressler, Erlangen (DE); Daniel Kotzian, Forchheim (DE)

(73) Assignee: Primetals Technologies Germany GmbH, Erlangen (DE)

(21) Appl. No.: 17/485,590

(22) Filed: Sep. 27, 2021

(30) Foreign Application Priority Data
Sep. 28, 2020 (EP) 20198745.0

(51) Int. Cl. B21B 37/58

(52) U.S. Cl. CPC B21B 37/58

(57) ABSTRACT

A metal strip is fed to a rolling stand by a feeding device and removed by a removing device. A control device cyclically determines, based on final thickness deviations of portions of the metal strip from a setpoint thickness of the metal strip on the exit side, setpoint values and outputs the determined setpoint values to final control elements. The final control elements include the feeding device, an adjusting device for the rolling gap of the rolling stand, a drive for driving rolls of the rolling stand, and/or the removing device. For the feeding device, the drive, and the removing device, the setpoint value is a setpoint speed or torque. For the adjusting device, the setpoint value is a setpoint rolling-gap value. The control device determines a setpoint value based on a number of final thickness deviations allowing for the inverse frequency response of the respective final control element.

### CROSS-REFERENCE TO RELATED APPLICATIONS

The present application claims the benefit of European Patent Application No. 20198745.0, entitled “ROLLING WITH ALLOWANCE FOR FREQUENCY RESPONSE”, filed Sep. 28, 2020, which is incorporated by reference in its entirety.

### BACKGROUND OF THE INVENTION

### 1. Field of the Invention

The present invention relates to a method, a control program, and a control device for operating a rolling mill, and a rolling mill operating based on the method.

### 2. Description of the Related Art

When producing metal strip, after the casting of a slab, the slab is first hot-rolled, so that a hot strip is created. The thickness of the hot strip usually lies in the range of a few millimeters, depending on the production process sometimes also somewhat above or below that, for example between 1.0 mm and 20 mm in the case of a normal hot rolling mill and between 0.6 mm and 6 mm in the case of a so-called ESP plant. In some cases, the hot strip is further processed without further thickness reduction. In other cases, after the hot rolling the strip thickness is reduced still further in a cold rolling mill. The aim of the cold rolling is the production of a cold-rolled metal strip of which the final thickness coincides with a target thickness as well as possible and with the smallest possible deviation.

The finished hot strip—that is to say after the hot rolling but before the rolling in the cold rolling mill—generally has thickness deviations. The thickness deviations often have both periodic components and stochastic components. Without compensation for these deviations, the metal strip also has such deviations after the cold rolling. Although the absolute extent of the deviations is less than in the case of the hot strip, the relative deviation persists. If therefore—for example—before the cold rolling the metal strip has a thickness of 3.0 mm and thickness deviations in the range of 30 μm and after the cold rolling the metal strip still has a thickness of 1.0 mm, without compensation for the thickness deviations the metal strip has after the cold rolling thickness deviations in the range of 10 μm.

Various procedures for compensating for such deviations are known in the prior art.

Thus, for example, it is known from EP 0 435 595 A2 to detect the thickness of the rolled metal strip on the exit side of a rolling stand and to perform thickness feedback control of the rolling stand. There is also compensation for fluctuations in tension, since they also influence the thickness of the rolled metal strip. To achieve relatively highly dynamic feedback control of the tension, between the feeding device and the rolling stand on the one hand and also between the rolling stand and a taking-up device arranged downstream of the rolling stand on the other hand there are rollers or similar elements by means of which the metal strip can be deflected before and/or after the rolling in the rolling stand. The procedure of EP 0 435 595 A2 is based on the idea that the feedback control by the feeding device itself and the taking-up device itself is very slow to react and the dynamics of the feedback control can be increased by the additional rollers. EP 0 435 595 A2 also includes a description of a procedure in which the thickness and the speed of the metal strip are detected on the entry side of the rolling stand and are used in the course of determining the adjustment of the rolling stand.

It is likewise known from EP 3 332 883 A1 to detect the thickness of the rolled metal strip on the exit side of a rolling stand and to perform thickness feedback control of the rolling stand. Periodic deviations are separated from stochastic deviations. Periodic deviations are considered to be caused by eccentricities of the rolls of the rolling stand. The correction of the adjustment of the rolling stand takes place correspondingly.

In the case of JP 58 068 414 A, the thickness of the still unrolled metal strip is detected on the entry side of the rolling stand and averaged over certain units of length. The average value is used for activating the adjustment of the rolling stand.

The earlier European patent application 20184420.6 of Primetals Technologies Germany GmbH, filing date Jul. 7, 2020, discusses an operating method for a rolling mill in which, for portions of the rolling stock, the thickness is in each case detected on the entry side of the rolling stand and on this basis precontrol values are determined for the rolling stand and/or the feeding device. Controlled variables may be the rolling gap, the feed rate, the tension, the rolling torque and the rolling speed. A thickness measurement may take place on the exit side. In the course of determining the precontrol values, allowance is made for the frequency response of the feeding device and/or of the rolling stand. The patent application 20184420.6 was not a prior publication on the filing date and therefore does not represent generally accessible state of the art.

### SUMMARY OF THE INVENTION

The present invention is based on an operating method for a rolling mill,
wherein a feeding device arranged upstream of a rolling stand of the rolling mill feeds a metal strip to the rolling stand,
wherein the rolling stand rolls the metal strip,
wherein a removing device arranged downstream of the rolling stand removes the metal strip from the rolling stand,
wherein a control device of the rolling mill cyclically determines in each case on the basis of a number of final thickness deviations of a corresponding number of portions of the metal strip from a setpoint thickness of the metal strip on the exit side in each case a number of setpoint values for a corresponding number of final control elements and outputs the determined setpoint values to the final control elements,
wherein the final control elements comprise the feeding device and/or an adjusting device of the rolling stand for setting a rolling gap of the rolling stand and/or a drive of the rolling stand for driving rolls of the rolling stand and/or the removing device,
wherein the setpoint value for the feeding device is a setpoint speed or a setpoint torque, the setpoint value for the adjusting device is a setpoint rolling-gap value, the setpoint value for the drive is a roll circumferential speed or a rolling torque and the setpoint value for the removing device is a setpoint speed or a setpoint torque.

The present invention is also based on a control program which comprises machine code that can be executed by a control device for a rolling mill, wherein the execution of the machine code by the control device brings about the effect that the control device operates the rolling mill according to such an operating method.

The present invention is also based on a control device for a rolling mill, wherein the control device is programmed with such a control program, so that the control device operates the rolling mill according to such an operating method.

The present invention is also based on a rolling mill for rolling a metal strip,
wherein the rolling mill has at least one rolling stand, a feeding device arranged upstream of the rolling stand, a removing device arranged downstream of the rolling stand and a control device,
wherein the feeding device feeds the metal strip to the rolling stand,
wherein the rolling stand rolls the metal strip,
wherein the removing device removes the metal strip from the rolling stand,
wherein the control device operates the rolling mill according to such an operating method.

The object of the present invention is to provide possibilities by means of which excellent compensation for exit-side thickness deviations of the metal strip can be achieved.

The object is achieved by an operating method for a rolling mill with the features of the independent claims. Advantageous configurations of the operating method are the subject of the dependent claims.

According to the invention, an operating method of the type mentioned at the beginning is configured such that the control device determines at least one of the setpoint values on the basis of the number of final thickness deviations with allowance for a description of the inverse frequency response of the respective final control element.

It has been recognized by the inventors that the extent to which a determined final thickness deviation is corrected depends not only on the final thickness deviation itself, but also on the range of the final thickness deviations. In particular, compensation for final thickness deviations of a higher frequency is generally only provided to a lesser extent and with a greater phase offset than for final thickness deviations of a lower frequency. To be able to compensate for final thickness deviations of a higher frequency also to the full extent and without a phase offset, allowance must therefore be made for the frequency response of the final control element. It may be the case that the measured-value acquisition also has a frequency response, for which allowance can also be made in this case. Allowance is made on the basis of a description of the inverse frequency response of the final control element (and if applicable also of the measuring device).

In many cases, the number of final thickness deviations is equal to 1. In this case, it is possible for example that the control device determines the—in this case only—final thickness deviation of the respective cycle on the basis of a final entry-side thickness of the portion of the metal strip with allowance for an entry speed, at which the portion of the metal strip enters the rolling stand, and an exit speed, at which the portion of the metal strip exits the rolling stand, on the basis of the mass flow equation. The portion of the metal strip to which the determined final thickness deviation relates is in this case the portion of the metal strip that is being rolled at that moment. This procedure realizes a so-called MFC (=mass flow control).

The entry speed is the speed at which the metal strip enters the rolling gap. The entry speed differs from the roll circumferential speed by a factor. The factor is usually referred to as the lag. In an analogous way, the exit speed is the speed at which the metal strip exits the rolling gap. The exit speed likewise differs from the roll circumferential speed by a factor. This factor is usually referred to as the lead.

The entry speed may also deviate from the feed rate. This is so because the feed rate is the speed at which the metal strip is delivered by the feeding device. In the case of a deviation, the deviation brings about the effect of a change in the tension that prevails in the metal strip on the entry side of the rolling stand. In an analogous way, the exit speed may also deviate from the removal rate. This is so because the removal rate is the speed at which the metal strip is taken up by the removing device. In the case of a deviation, the deviation brings about the effect of a change in the tension that prevails in the metal strip on the exit side of the rolling stand.

In the case of an MFC, it is possible that the final entry-side thickness of the portion of the metal strip is a thickness of the portion of the metal strip that is detected on the entry side of the rolling stand before the respective cycle for the portion of the metal strip being rolled at that moment. In this case, a single value of the entry-side thickness is detected for the corresponding portion of the metal strip and is used directly as the final entry-side thickness of the corresponding portion of the metal strip. Alternatively, it is possible that the control device determines the final entry-side thickness of the portion of the metal strip by a filtering of thicknesses detected on the entry side of the rolling stand for a plurality of portions of the metal strip.

As already mentioned, the entry-side detection of the entry-side thickness of the portion of the metal strip takes place at a point in time that lies before the determination of the final thickness deviation. In combination with a generally known process of tracking, it can however be readily determined at which point in time the corresponding portion of the metal strip is rolled. Analogous statements also apply when a number of thicknesses detected on the entry side are used.

The filtering is generally a low-pass filtering, by means of which high-frequency fluctuations are filtered out. It is preferably a zero-phase filtering. Zero-phase filtering processes are generally known to those skilled in the art. The so-called IIR (=infinite impulse response) may be mentioned just by way of example. Another possibility for implementing a zero-phase filtering is a convolution with a symmetric impulse response of an FIR filter (FIR=finite impulse response).

Alternatively, it is possible that although—as in the case of an MFC—the number of final thickness deviations of the respective cycle is equal to 1, the final thickness deviation relates to a portion of the metal strip rolled before the portion of the metal strip being rolled at that moment. In this case, a so-called FBC (=feedback control) is realized.

In the case of an FBC, it is possible that a measuring device which detects the exit-side thickness and feeds it to the control device is arranged between the rolling stand and the removing device, and the final thickness deviation is determined on the basis of the detected exit-side thickness and the exit-side setpoint thickness. Alternatively, it is possible in the case of an FBC that the control device determines the final thickness deviation by a filtering of a plurality of provisional thickness deviations of a corresponding number of portions of the metal strip of the exit-side setpoint thickness. The filtering is generally a low-pass filtering, by means of which high-frequency fluctuations are filtered out.

The filtering is preferably a zero-phase filtering. In this case, consequently a first part of the provisional thickness deviations relates to portions of the metal strip which, although already rolled, were rolled after the portion of the metal strip to which the final thickness deviation relates. Similarly, a second part of the provisional thickness deviations relates to portions of the metal strip which have not only already been rolled but even were rolled before the portion of the metal strip to which the final thickness deviation relates.

For the provisional thickness deviations of the first part of the provisional thickness deviations, the control device determines the corresponding provisional thickness deviations on the basis of a respective corresponding final entry-side thickness of the metal strip with allowance for an entry speed, at which the respective portion of the metal strip enters the rolling stand, and an exit speed, at which the respective portion of the metal strip exits the rolling stand, on the basis of the mass flow equation. The corresponding speeds are known, because the corresponding portions have already been rolled. The determination of these provisional thickness deviations is therefore readily possible.

By analogy with the procedure in the case of an MFC, it is possible that, for the first part of the provisional thickness deviations, the respective final entry-side thickness of the portion of the metal strip is a thickness of the respective portion of the metal strip that is detected on the entry side of the rolling stand for the respective portion of the metal strip. Alternatively—again by analogy with the procedure in the case of an MFC—it is possible that the control device determines the respective final entry-side thickness of the respective portion of the metal strip by a filtering of thicknesses detected on the entry side of the rolling stand for a plurality of respective portions of the metal strip.

For the provisional thickness deviations of the already mentioned second part of the provisional thickness deviations, the same procedure can be followed. It is therefore possible that, here too, the control device determines the provisional thickness deviations on the basis of the mass flow equation. Preferably, however, a measuring device arranged between the rolling stand and the removing device detects the exit-side thickness in each case for portions of the metal strip and feeds it to the control device. In this case, the second part of the provisional thickness deviations may relate to portions of the metal strip that were rolled before the portion of the metal strip to which the final thickness deviation relates. For the second part of the provisional thickness deviations, the control device may therefore determine the respective provisional thickness deviation on the basis of the respectively detected exit-side thickness and the exit-side setpoint thickness.

It is alternatively possible that the number of final thickness deviations of the respective cycle is greater than 1. The associated portions of the rolling stock have in this case all already been rolled. The setpoint values end up being determined for a final thickness deviation which relates to a location downstream of the rolling stand.

Also in the case of using a number of final thickness deviations, it is possible that the control device determines the final thickness deviations by a filtering of a plurality of provisional thickness deviations of a corresponding number of portions of the metal strip of the exit-side setpoint thickness of the metal strip. The filtering is generally a low-pass filtering, by means of which high-frequency fluctuations are filtered out.

Preferably, the filtering is a zero-phase filtering. In this case, the control device—as before—determines a first part of the provisional thickness deviations on the basis of a respective corresponding final entry-side thickness of the metal strip with allowance for an entry speed, at which the respective portion of the metal strip enters the rolling gap, and an exit speed, at which the respective portion of the metal strip exits the rolling gap, on the basis of the mass flow equation.

Also—similarly as before—for the first part of the provisional thickness deviations, the respective final entry-side thickness of the portion of the metal strip may alternatively be a thickness of the respective portion of the metal strip that is detected on the entry side of the rolling stand for the respective portion of the metal strip or the control device may determine the respective final entry-side thickness of the respective portion of the metal strip by a filtering of thicknesses detected on the entry side of the rolling stand for a plurality of respective portions of the metal strip.

As before, a measuring device is preferably arranged between the rolling stand and the removing device. This measuring device may detect for rolled portions of the metal strip in each case a measured value for the respective final thickness deviation. As a result, it is possible that the control device uses the measured value detected in each case for the respective portion for a second part of the provisional thickness deviations.

There are various possibilities for the manner in which allowance is made for the inverse frequency response.

In the case where the number of final thickness deviations is greater than 1, it is possible that the description of the inverse frequency response of the respective final control element of the control device is specified as a respective frequency-response characteristic and that the control device determines the respective setpoint value by a transformation of the progression of the final thickness deviations into the frequency domain, a subsequent multiplication of the transformed progression of the final thickness deviation with the respective frequency-response characteristic and a subsequent transformation back into the time domain.

It is generally known that a multiplication in the frequency domain corresponds to a convolution in the time domain. In the case where the number of final thickness deviations is greater than 1, it is therefore alternatively possible that the description of the inverse frequency response of the respective final control element of the control device is specified as a respective convolution kernel and that the control device determines the respective setpoint value by a convolution of the progression of the final thickness deviations with the respective convolution kernel.

Irrespective of the number of final thickness deviations—that is to say both in the event that this number is equal to 1 and in the event that this number is greater than 1—it is however always possible
that the description of the inverse frequency response of the respective final control element of the control device is specified by a respective inverse model,
that the control device feeds the final thickness deviation of a portion of the metal strip to the respective inverse model and
that the control device using the fed final thickness deviation by means of the respective inverse model on the one hand correctively adjusts a respective internal state of the respective inverse model and on the other hand determines the respective setpoint value.

This procedure is preferred at present. In particular, the computational effort is minimized by this procedure, since the control device only has to determine in each case a single final thickness deviation. This procedure therefore involves the least computational effort.

The detection of the frequency-response characteristic, and on this basis the determination or parameterization of the inverse model or the determination of the gains for the individual frequency ranges or the determination of the convolution kernel may take place in an automated manner In particular, while the rolling mill is in operation, defined minor disturbances may be imparted to the setpoint rolling-gap value of the rolling stand or some other manipulated variable of a final control element. These disturbances are reflected on the exit side of the rolling stand in corresponding fluctuations of the exit-side thickness of the metal strip. If a measuring device by means of which this exit-side thickness is detected is arranged downstream of the rolling stand, the frequency-response characteristic can be determined in an automated manner by a combined evaluation of the imparted disturbances on the one hand and the fluctuations of the exit-side thickness on the other hand. This is known in principle to those skilled in the art.

The object is also achieved by a control program with the features of the independent claims. According to the invention, the execution of the control program brings about the effect that the control device operates the rolling mill according to an operating method according to the invention.

The object is also achieved by a control device with the features of the independent claims. According to the invention, the control device is programmed with a control program according to the invention, so that the control device operates the rolling mill according to an operating method according to the invention.

The object is also achieved by a rolling mill with the features of the independent claims. According to the invention, the control device operates the rolling mill according to an operating method according to the invention.

### BRIEF DESCRIPTION OF THE DRAWINGS

The properties, features and advantages of this invention described above and also the manner in which they are achieved become clearer and more clearly understandable in connection with the following description of the exemplary embodiments, which are explained more specifically in conjunction with the schematically represented drawings, in which:

FIG. 1 shows a rolling mill,

FIG. 2 shows a flow diagram,

FIG. 3 shows a metal strip from above,

FIG. 4 shows a structural setup of a control device,

FIG. 5 shows a possible configuration of FIG. 4,

FIG. 6 shows a modification of FIG. 5,

FIG. 7 shows a further possible configuration of FIG. 4,

FIG. 8 shows a modification of FIG. 7,

FIG. 9 shows part of the metal strip and

FIG. 10 shows a structural overall setup of a control device.

### DETAILED DESCRIPTION

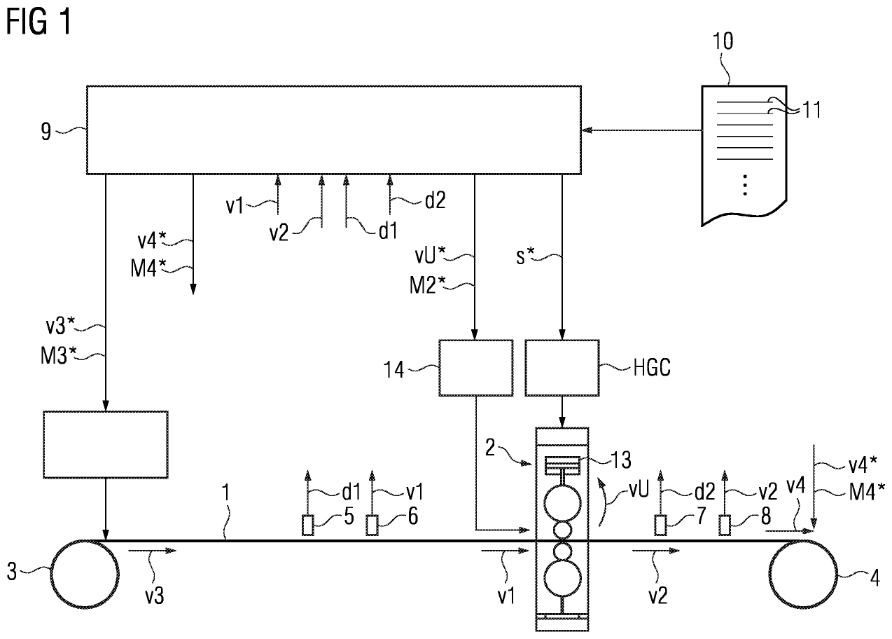

According to FIG. 1, a rolling mill for rolling a metal strip 1 has a rolling stand 2. The rolling stand 2 may be in particular a cold rolling stand, in which consequently a cold rolling of the metal strip 1 takes place. Generally, in a way corresponding to the representation in FIG. 1, the rolling stand 2 comprises in addition to its working rolls at least also two back-up rolls. For example, it may be formed as a four-high stand. In some cases, the rolling stand 2 also has even more rolls. For example, the rolling stand 2 may be formed as a six-high stand (two working rolls, two intermediate rolls, two back-up rolls) or as a 12-roller rolling stand or as a 20-roller rolling stand. The metal strip 1 may consist of steel, of aluminum or of some other metal, for example of copper or of brass.

In the rolling stand 2, the metal strip 1 is rolled. During the rolling of the metal strip 1, the metal strip 1 runs at an entry speed v 1 into the rolling stand 2 and runs at an exit speed v2 out of the rolling stand 2. During the rolling of the metal strip 1, the individual rolls of the rolling stand 2 rotate at a roll circumferential speed vU. The roll circumferential speed vU generally differs both from the entry speed v1 and from the exit speed v2 by a respective factor. The factor by which the roll circumferential speed vU differs from the entry speed v1 is usually referred to as the lag. In an analogous way, the factor by which the roll circumferential speed vU differs from the exit speed v2 is usually referred to as the lead.

The rolling mill also has a feeding device 3. The feeding device 3 is arranged upstream of the rolling stand 2. The metal strip 1 is fed to the rolling stand 2 at a feed rate v3 by the feeding device 3. According to FIG. 1, the feeding device 3 is formed as a coiler. It could however also be formed differently, for example as a driver or as a further rolling stand different from the rolling stand 2. The feeding device 3 may also be formed as a so-called S-roller, that is to say a number of rollers by way of which the metal strip 1 ends up being guided in an S-shaped manner

The rolling mill also has a removing device 4. The removing device 4 is arranged downstream of the rolling stand 2. The metal strip 1 is removed from the rolling stand 2 at a removal rate v4 by the removing device 4. According to FIG. 1, the removing device 4 is formed as a coiler. It could however also be formed differently, for example as a driver or as a further rolling stand different from the rolling stand 2. The removing device 4 may also be formed as a so-called S-roller, that is to say a number of rollers by way of which the metal strip 1 ends up being guided in an S-shaped manner

The feed rate v3 is the speed at which the metal strip 1 is fed to the rolling stand 2 by the feeding device 3. It may deviate from the entry speed v1. In the case of a deviation, the deviation brings about the effect of a change in the tension that prevails in the metal strip 1 on the entry side of the rolling stand 2. In an analogous way, the removal rate v4 is the speed at which the metal strip 1 is removed from the rolling stand 2 by the removing device 4. It may deviate from the exit speed v2. In the case of a deviation, the deviation brings about the effect of a change in the tension that prevails in the metal strip 1 on the exit side of the rolling stand 2.

It is possible that a measuring device 5 is arranged between the feeding device 3 and the rolling stand 2. By means of the measuring device 5, if it is present, a measured value for the thickness d1 of the metal strip 1 is repeatedly detected in a cyclical manner on the entry side of the rolling stand 2. Furthermore, there may additionally be a further measuring device 6, by means of which a measured value for a speed of the metal strip 1 is repeatedly detected on the entry side of the rolling stand 2. This measured value may be used in particular as a measured value for the entry speed v1.

According to FIG. 1, there may also be a further measuring device 7 arranged between the rolling stand 2 and the removing device 4. By means of the measuring device 7, if it is present, a measured value for the thickness d2 of the metal strip 1 is repeatedly detected in a cyclical manner on the exit side of the rolling stand 2. Furthermore, there may additionally be a further measuring device 8, by means of which a measured value for a speed of the metal strip 1 is repeatedly detected on the exit side of the rolling stand 2. This measured value may be used in particular as a measured value for the exit speed v2.

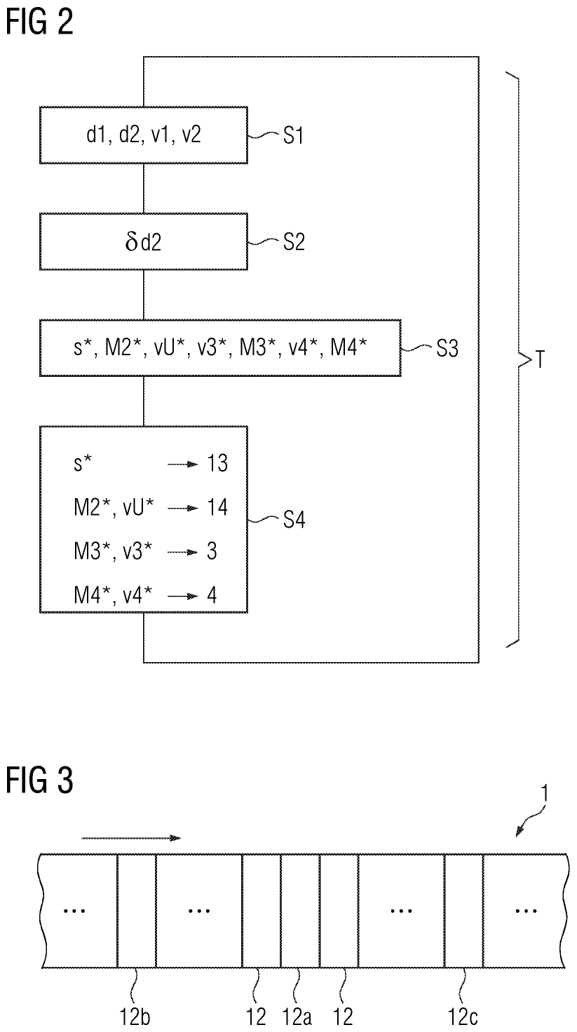

The respectively detected thickness values d1, d2 and also the respectively detected values for the entry speed v1 and the exit speed v2 are fed to a control device 9, which is likewise a component part of the rolling mill. The control device 9 is programmed with a control program 10. The control program 10 comprises machine code 11, which can be executed by the control device 9. The programming of the control device 9 with the control program 10 or the execution of the machine code 11 by the control device 9 brings about the effect that the control device 9 operates the rolling mill according to an operating method, which is explained more specifically below, first in conjunction with FIG. 2 and then also the other figures.

According to FIG. 2, the control device 9 repeatedly performs steps S1 to S4 in a cyclical manner Usually, the control device 9 even performs steps S1 to S4 on a strictly clocked basis, that is to say with a fixed cycle time T. The cycle time T generally lies far below 1 s, in particular below 100 ms. For example, it may lie at 8 ms.

In a way corresponding to the representation in FIG. 3, the metal strip 1 may be divided into a number of portions 12. The division is only virtual, that is to say purely notional. In FIG. 3, some of the portions 12 are additionally provided with a lowercase letter (a, b etc.), in order to be able to distinguish them from one another if need be. The arrow in FIG. 3 denotes the transporting direction of the metal strip 1.

The following statements in relation to FIG. 2 and also the other figures respectively relate to a single cycle, that is to say a one-off performance of steps S1 to S4. In a way corresponding to the representation in FIG. 3, in the respective cycle a single portion 12 of the metal strip 1 is rolled in the rolling stand 2. The portion 12 of the metal strip 1 being rolled at that moment is provided below with the designation 12a. In the preceding cycle, the preceding portion 12 of the metal strip 1 was rolled. In the next cycle, the following portion 12 of the metal strip 1 will be rolled. Analogous statements apply to the other portions 12 of the metal strip 1.

According to FIG. 2, in step S1 the control device 9 receives the respectively detected thickness values d1, d2 and if applicable also the respectively detected values for the entry speed v1 and the exit speed v2. In this cycle, the portion 12a is rolled. The detected thickness value d1 relates to another portion 12 of the metal strip 1, which is rolled after the portion 12 of the metal strip 1 being rolled at that moment. For example, the thickness value d1 may relate to the portion 12 of the metal strip 1 denoted by the designation 12b. By contrast, the detected thickness value d2 relates to a portion 12 of the metal strip 1 that has already been rolled, that is to say was rolled before the portion 12 of the metal strip 1 being rolled at that moment. For example, the thickness value d2 may relate to the portion 12 of the metal strip 1 that is denoted by the designation 12c. The detected speeds v1, v2 in turn relate to the portion 12a being rolled at that moment.

In step S2, the control device 9 selects a number of final thickness deviations δd2. The final thickness deviations δd2 selected in step S2 are the final thickness deviations δd2 that are used in step S3 and, on the basis thereof, also in S4. Generally, the number of selected thickness deviations δd2 is equal to 1. The control device 9 therefore selects in step S2 a single final thickness deviation δd2. Also possible, however, are configurations of the present invention in which the control device 9 selects in step S2 a number of final thickness deviations δd2. In this case, each individual selected final thickness deviation δd2 relates to a portion 12 of a corresponding number of portions 12 of the metal strip 1. In the case of a single selected final thickness deviation δd2, the selected final thickness deviation δd2′ either relates to the portion 12a or to the portion 12c.

Each individual final thickness deviation δd2 is the difference between a final thickness d2′ of the metal strip 1 on the exit side of the rolling stand 2 and the associated setpoint thickness d2* of the metal strip 1 on the exit side of the rolling stand 2. The respective final thickness d2′ is therefore the corresponding thickness d2′ of the metal strip 1 after the rolling in the rolling stand 2. The respective final thickness d2′ relates to the corresponding portion 12 of the metal strip 2. Possible implementations of step S2 will become evident from the statements made later.

In step S3, the control device 9 determines a number of setpoint values s*, M2*, vU*, v3*, M3*, v4*, M4* for a corresponding number of final control elements 13, 14, 3, 4. The control device 9 uses the mentioned number of final thickness deviations δd2 in the course of determining the setpoint values s*, M2*, vU*, v3*, M3*, v4*, M4*. In step S4, the control device 9 outputs the determined setpoint values s*, M2*, vU*, v3*, M3*, v4*, M4* to the final control elements 13, 14, 3, 4 (to be more precise: to controllers arranged upstream of the final control elements 13, 14, 3, 4). The setpoint values s*, M2*, vU*, v3*, M3*, v4*, M4* may be base setpoint values, that is to say setpoint values which completely, or at least almost completely, stipulate a resultant setpoint value for the corresponding final control element 13, 14, 3, 4. However, they are often additional setpoint values, that is to say setpoint values which are fed forward onto such a base setpoint value or are added to such a base setpoint value.

The number of final control elements 13, 14, 3, 4 and the type of final control elements 13, 14, 3, 4 may be chosen according to requirements. For example, one of the final control elements 13, 14, 3, 4 may be an adjusting device 13 of the rolling stand 2 for setting a rolling gap of the rolling stand 2. In this case, the associated setpoint value s* is a setpoint rolling-gap value s*, which is for example output to a so-called HGC (hydraulic gap control). Alternatively or additionally, one of the final control elements 13, 14, 3, 4 may be a drive 14 of the rolling stand 2 for driving rolls of the rolling stand 2. In this case, the associated setpoint value vU*, M2* is a roll circumferential speed vU* or a rolling torque M2*. Alternatively or additionally, one of the final control elements 13, 14, 3, 4 may be the feeding device 3. In this case, the associated setpoint value v3*, M3* is a setpoint speed v3* or a setpoint torque M3*. Alternatively or additionally, one of the final control elements 13, 14, 3, 4 may be the removing device 4. In this case, the associated setpoint value v4*, M4* is a setpoint speed v4* or a setpoint torque M4*. In the case of very small exit-side thicknesses d2, it may also sometimes be advisable to appropriately activate the feeding device 3 and/or the removing device 4 instead of the adjusting device 13 and the drive 14 of the rolling stand 2, so that, to compensate for thickness errors of the metal strip 1, the tension in the metal strip 1 is varied in a specifically selective manner on the entry side and/or on the exit side of the rolling stand 2.

In many cases, it will be advisable that the final control elements 13, 14, 3, 4 comprise either the adjusting device 13 of the rolling stand 2, the drive 14 of the rolling stand 2 and the feeding device 3 or comprise the adjusting device 13 of the rolling stand 2, the drive 14 of the rolling stand 2 and the removing device 4. In a way corresponding to this, the control device 9 determines as setpoint values the setpoint value s* for the rolling gap and the setpoint value M2* for the rolling torque or the setpoint value vU* for the roll circumferential speed vU and furthermore either the setpoint value v3* or M3* for the feeding device 3 or alternatively the setpoint value v4* or M4* for the removing device 4.

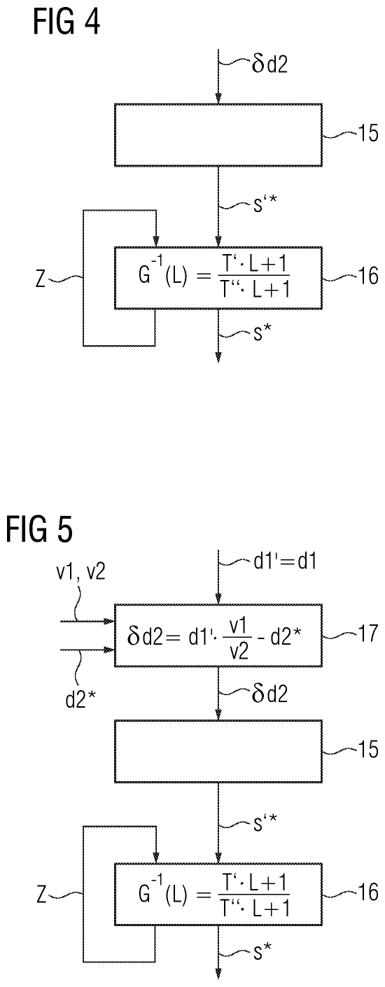

The essence of the invention is the manner in which the control device 9 uses the mentioned number of final thickness deviations δd2 in step S3 in the determination of the setpoint values s*, M2*, vU*, v3*, M3*, v4*, M4*. This manner is explained more specifically below in conjunction with FIG. 4 for the determination of the setpoint rolling-gap value s* for the adjusting device 13. Analogous statements apply to the other final control elements 3, 4, 14 and the other setpoint values M2*, vU*, v3*, M3*, v4*, M4*. Furthermore, the present invention is explained in conjunction with a single final thickness deviation δd2. Analogous statements apply to the use of a number of final thickness deviations δd2.

According to FIG. 4, the control device 9 comprises a controller block 15 and a modification block 16. The division into the controller block 15 and the modification block 16 takes place in order to be able to explain the present invention more easily. In principle, the controller block 15 and the modification block 16 can also be combined into one and the same block. Also, with corresponding adaptation of the variables fed to the respective block 15, 16 and the variables delivered by the respective block 15, 16, the sequence of the blocks 15, 16 can be changed over. The controller block 15 and the modification block 16 are usually implemented by the control device 9 on the basis of the control program 10 being configured as software blocks.

The controller block 15 is fed the final thickness deviation δd2. The controller block 15 determines on the basis of a controller characteristic stipulated by the implementation of the controller block 15 a provisional setpoint value s′*. The controller characteristic may be implemented for example in the manner of a P controller (that is to say a proportional-action controller), a PI controller (that is to say a proportional-plus-integral-action controller), a controller structure implemented by using an observer, etc. The controller block 15 as such may also be formed as in the prior art.

The provisional setpoint value s′* is transferred from the controller block 15 to the modification block 16. The modification block 16 modifies the provisional setpoint value s′* and thus determines the (final) setpoint value s*. When doing so—and this is the decisive point—allowance is made in the modification block 16 for a description of the inverse frequency response of the adjusting device 13.

As the end result, a description which directly characterizes the frequency response of the adjusting device 13 is therefore specified to the control device 9. To put it another way: the frequency response of the adjusting device 13 can be determined on the basis of the mentioned description. The control device 9 therefore not only determines the setpoint value s* in a manner by means of which allowance is made for the corresponding inverse frequency response. Rather, the control device 9 explicitly identifies the corresponding inverse frequency response as such. Therefore, characteristic variables that define the inverse frequency response are known to the control device 9. This is explained more specifically below for the rolling stand 2 and its adjustment.

The rolling stand 2 can be modeled in various ways. In the simplest case, the rolling stand 2 is modeled as a PT1 element. Alternatively, higher-order modeling comes into consideration. The modeling describes the rolling stand 2 as such, if applicable including its control (HGC).

The frequency response of the rolling stand 2 can be described for example by a transfer function. In the following—in the generally customary way—the transfer function as such is denoted by G. The Laplace operator is denoted by L. This procedure is followed in the present case because the designation s* has already been allocated, to be specific as the designation for the setpoint rolling-gap value. In the usual way, the actual rolling-gap value must therefore be provided with the designation s. However, usually the Laplace operator is also denoted by s.

Using the designation s* for the setpoint rolling-gap value and the designation s for the Laplace operator could therefore cause unnecessary confusion.

With the stipulation mentioned, the transfer function G(L) can be written as

$$G ( L ) = \frac{{b}_{m} \cdot {L}^{m} + {b}_{m - 1} \cdot {L}^{m - 1} + … + {b}_{1} \cdot L + {b}_{0}}{{c}_{n} \cdot {L}^{n} + {c}_{n - 1} \cdot {L}^{n - 1} + … + {c}_{1} \cdot L + {c}_{0}} \qquad ( 1 )$$

where b, (with i=1,2 . . . m) and c (with j=1,2 . . . n) are constant coefficients. The degree m of the numerator polynomial is, as a maximum, equal to the degree n of the denominator polynomial. If the rolling stand 2 is modeled as a PT1 element, the transfer function G(L) is obtained for example as

$$G ( L ) = \frac{1}{{T}^{′} \cdot L + 1} \qquad ( 2 )$$

where T′ is a characteristic time constant of the adjusting device 13.

For the associated inverse transfer function G⁻¹(L), the following applies in the general case

$${G}^{- 1} ( L ) = \frac{1}{G ( L )} = \frac{{c}_{n} \cdot {L}^{n} + {c}_{n - 1} \cdot {L}^{n - 1} + … + {c}_{1} \cdot L + {c}_{0}}{{b}_{m} \cdot {L}^{m} + {b}_{m - 1} \cdot {L}^{m - 1} + … + {b}_{1} \cdot L + {b}_{0}} \qquad ( 3 )$$

The inverse transfer function G⁻¹(L) is consequently clearly defined. If the rolling stand 2 is modeled as a PT1 element, the associated inverse transfer function G⁻¹(s) is obtained exactly as

$${G}^{- 1} ( L ) = \frac{T ' \cdot L + 1}{1} \qquad ( 4 )$$

If the inverse transfer function G⁻¹(L) is modeled exactly, the modeled response of the rolling stand 2 however often becomes unstable. In some cases, even the response of the real rolling stand 2 may become unstable. For example, the inverse of a PT1 element gives a PD element. A PD element amplifies high frequencies extremely. Also, the theoretically determinable output signal of a PD element cannot be implemented in reality. The cause of this are setting limitations of the adjusting device 13. To ensure the stability and feasibility, the denominator polynomial of the inverse transfer function G⁻¹(L) is therefore extended by a component which is proportional to the highest power of L in the numerator of the inverse transfer function G⁻¹(L). This is known in principle to those skilled in the art. Reference can be made in this respect to the textbook “Stabile Neuronale Online Identifikation and Kompensation statischer Nichtlinearitäten” [Stable neural online identification and compensation for static nonlinearities] by Thomas Frenz. The actually used inverse modeling of the frequency response of the rolling stand 2 is consequently described by a modified inverse transfer function G⁻¹(L), which has the form

$${G}^{- 1} ( L ) = \frac{{T}^{′} \cdot L + 1}{{T}^{″} \cdot L + 1} \qquad ( 5 )$$

r is a small time, that is to say a time that is considerably smaller than the characteristic time constant T′ of the rolling stand 2. The smaller the time T″ can be chosen to be, the better the modeling of the inverse frequency response of the rolling stand 2 is. In practice, the time T″ will be chosen to be equal to the cycle time T or approximately equal to the cycle time T.

On account of the above facts, it is possible, in a way corresponding to the representation in FIG. 4, to specify a corresponding inverse model of the adjusting device 13 to the control device 9 by corresponding implementation of the modification block 16. The modification block 16 therefore corresponds to the inverse model. As previously explained, the modification block 16 or the inverse model describes the inverse frequency response of the adjusting device 13. Allowance can be made according to requirements for transporting times, constant dead times and the like inside or outside the modification block 16.

The modification block 16 is fed—on a clocked basis with the cycle time T—in each case the selected final thickness deviation δd2 of the corresponding portion 12 of the metal strip 1. The control device 9 determines by means of the modification block 16, with additional allowance for an internal state Z of the inverse model 16, the setpoint value s* for the adjusting device 13 and outputs the setpoint value s* to the adjusting device 13. Furthermore, the control device 9 correctively adjusts the internal state Z by using the selected final thickness deviation δd2 and the previous internal state Z of the modification block 16. The allowance for the internal state Z and the corrective adjustment of the internal state Z are required, since otherwise the modification block 16 could not store any knowledge of the previous progression of the final thickness deviation δd2 and consequently could not model a frequency response, but merely a purely proportional response. The state Z may alternatively be a scalar or a vector quantity.

As already mentioned, analogous statements apply to the other final control elements 14, 3, 4.

Specific possible configurations of the present invention are explained more specifically below in conjunction with the other figures. In respect of these configurations, it is always assumed that the number of selected final thickness deviations δd2 of the respective cycle is equal to 1.

In a way corresponding to the representation in FIG. 5, a determination block 17 is arranged upstream of the controller block 15. By analogy with the controller block 15 and the modification block 16, the determination block 17 is usually implemented by the control device 9 on the basis of the control program 10 being configured as a software block. The software block 17 is fed a final entry-side thickness d1′. The final entry-side thickness d1′ relates to the portion 12 of the metal strip 1 that is being rolled in the respective cycle, that is to say the portion 12a.

In respect of the configuration according to FIG. 5, the final entry-side thickness d1′ is directly identical to a thickness d1 detected on the entry side, that is to say the thickness d1 that was detected by means of the measuring device 5 on the entry side of the rolling stand 2 for the same portion 12 of the metal strip 1. The detection of the entry-side thickness d1 took place of course in an earlier cycle. In combination with an intermediate storage and a tracking process, it can however be readily determined in which cycle the detected entry-side thickness d1 must be used as the final entry-side thickness d1′. Therefore in addition to just the determination, the determination block 18 also implements a transporting model, which models the transport of a portion 12 from the location of the detecting device 5 to the rolling stand 2.

The determination block 17 is also fed the current entry speed v1 and the current exit speed v2. These values may be for example the measured values detected in the respective cycle by means of the measuring devices 6 and 8. Finally, the determination block 17 is fed the setpoint value d2* for the exit-side thickness of the metal strip 1, that is to say the setpoint thickness d2*.

The determination block 17 determines the final thickness deviation δd2 on the basis of the mass flow equation. In particular, the determination block 17 determines the final thickness deviation δd2 on the basis of the relationship

$$δ d 2 = d {1}^{′} \cdot \frac{v 1}{v 2} - d {2}^{*} \qquad ( 6 )$$

The determined final thickness deviation δd2 relates to the portion 12a of the metal strip 1 that is being rolled in the rolling stand 2 at that moment. By means of the configuration according to FIG. 5, a so-called mass flow control is therefore realized.

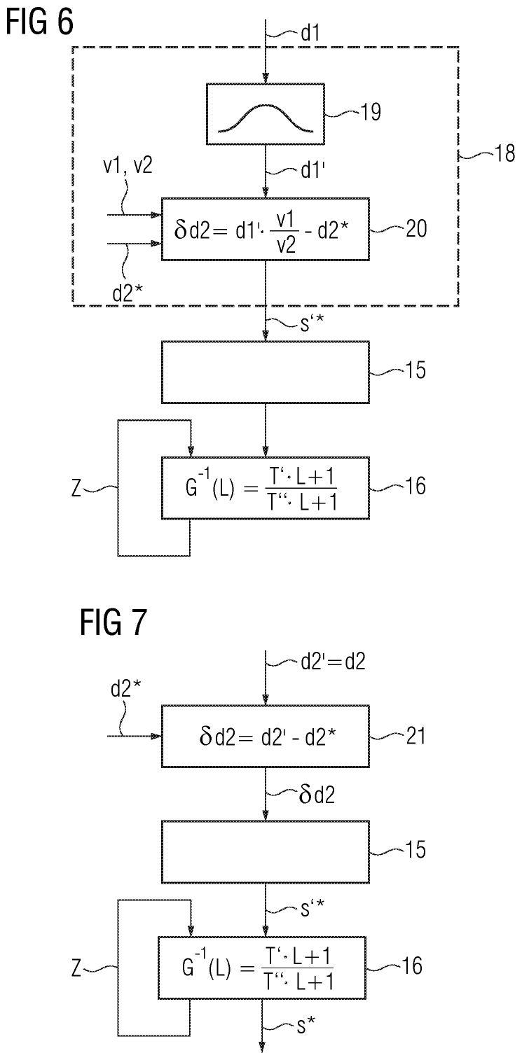

FIG. 6 shows a modification of FIG. 5. Also in respect of the modification of FIG. 6, the selected final thickness deviation δd2 relates to the portion 12a of the metal strip 1 that is being rolled in the rolling stand 2 at that moment. Therefore, a mass flow control is also realized by means of the configuration according to FIG. 6. As a difference from FIG. 5, however, the determination block 17 is replaced by another determination block 18. By analogy with the determination block 17, the determination block 18 is generally implemented by the control device 9 on the basis of the control program 10 being configured as a software block.

The determination block 18 comprises a transporting model 19 and a computing block 20. By means of the transporting model 19, a modeling of the tracking of portions 12 after passing the detecting device 5 takes place. Furthermore, a determination of the final entry-side thickness d1′ takes place. This determination takes place by a filtering of a number of thicknesses d1 detected on the entry side of the rolling stand 2. This is indicated in FIG. 6 by the transporting model 19 implementing a filter curve as a filter function. The final entry-side thickness d1′ is fed to the computing block 20, which—by analogy with the determination block 17—determines the final thickness deviation δd2 on the basis of the mass flow equation.

The filtering of the transporting model 19 is generally a low-pass filtering, by means of which high-frequency fluctuations are filtered out. It is preferably a zero-phase filtering.

In respect of the configuration according to FIG. 7, the final thickness deviation δd2 relates to a portion 12c of the metal strip 1 which has already been rolled before the portion 12a of the metal strip 1 being rolled at that moment. By means of the configuration according to FIG. 7, therefore a so-called feedback control is realized.

Specifically, it is possible that, in a way corresponding to the representation in FIG. 7, the controller block 15 is fed as the final thickness deviation δd2 a value which is determined directly and readily on the basis of the measured value of the measuring device 7. In particular, the difference between the setpoint thickness d2* and a final thickness d2′ relating to the exit side of the rolling stand 2 may be determined in a computing block 21 and output as the final thickness deviation δd2 to the controller block 15. In the configuration according to FIG. 7, the computing block 21 is directly fed the thickness d2 detected on the exit side for the portion 12c as the final thickness d2′. The computing block 21 may likewise be implemented by the control device 9 on the basis of the control program 10 being configured as a software block.

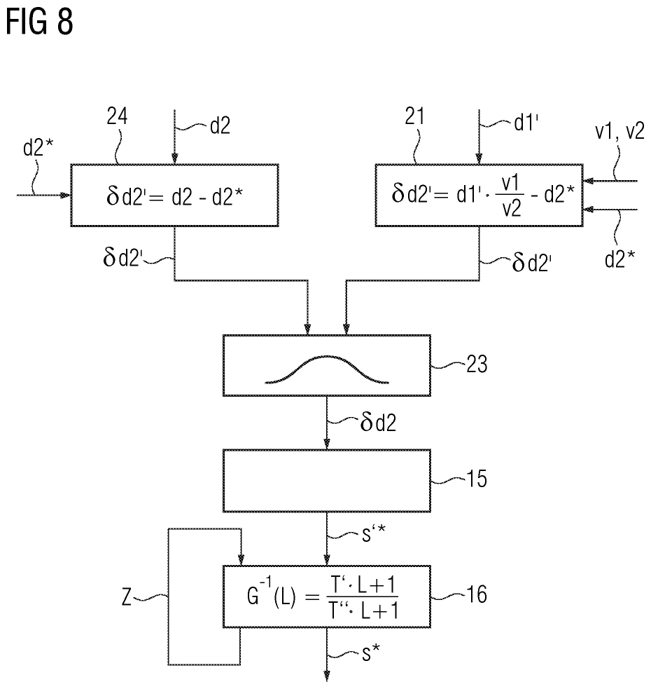

FIG. 8 shows a modification of FIG. 7. Also in respect of the modification of FIG. 8, the determined final thickness deviation δd2 relates to the portion 12c of the metal strip 1 that has already been rolled in the rolling stand 2. Also by means of the configuration according to FIG. 6, therefore a feedback control is realized. As a difference from FIG. 7, however, the computing block 21 is replaced by a computing block 22 and a downstream filter block 23. In addition, a further computing block 24 may be connected in parallel with the computing block 22. By analogy with the other blocks, the blocks 22 and 23, and if applicable also the block 24, are generally implemented by the control device 9 on the basis of the control program 10 being configured as a software block.

The filter block 23 is fed—in relation to the respective cycle—a plurality of provisional thickness deviations δd2′. The provisional thickness deviations δd2′ relate to a corresponding number of portions 12 of the metal strip 1. They indicate the respective deviation of the thickness d2 of the corresponding portion 12 of the metal strip 1 from the exit-side setpoint thickness d2*. The filter block 23 determines the final thickness deviation δd2 by a filtering of the respectively fed provisional thickness deviations δd2′. The filtering is generally a low-pass filtering, by means of which high-frequency fluctuations are filtered out. To realize its filtering, the filter block 23 additionally also implements a transporting model, which models the transport of the portions 12 from the rolling stand 2 to the location of the detecting device 7 and, if required, beyond there.

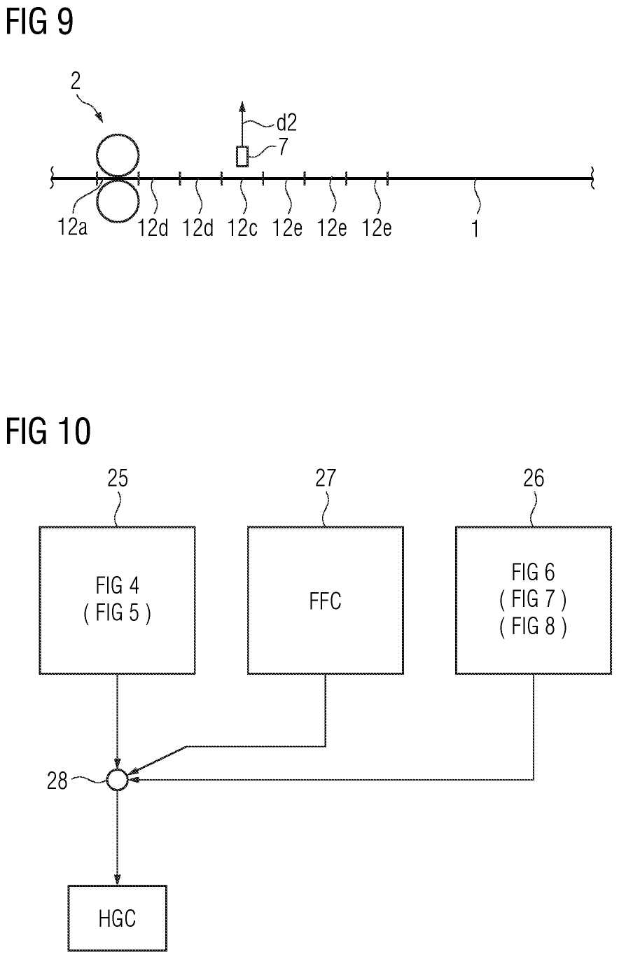

In a preferred configuration, in a way corresponding to the representation in FIG. 9, the filtering is a zero-phase filtering. This is thereby evident from FIG. 9, since the portions 12 of the metal strip of which the provisional thickness deviations δd2′ are entered into the determination of the final thickness deviation δd2 are marked there. It is evident that on the one hand the provisional thickness deviations δd2′ of portions 12d are entered into the determination. Although these portions 12d have already been rolled, they were rolled after the portion 12c to which the final thickness deviation δd2 relates. The portion 12a may be one of the portions 12d. As represented in FIG. 9, the portions 12d are generally located upstream of the measuring device 7, and therefore have not yet passed the measuring device 7. On the other hand, provisional thickness deviations δd2′ which relate to portions 12e of the metal strip 1 are generally entered into the determination of the final thickness deviation δd2 in the course of the zero-phase filtering. These portions 12e have not only already been rolled, but were even rolled before the portion 12c to which the final thickness deviation δd2 relates. The portions 12e are therefore generally located downstream of the measuring device 7, and therefore have already passed the measuring device 7. Finally, the provisional thickness deviation δd2′ of the portion 12c of which the exit-side thickness d2 is being detected at the time in the respective cycle by means of the measuring device 7 is also entered into the determination of the final thickness deviation δd2.

For the provisional thickness deviations δd2′ of the portions 12d there is not yet a measured value for the exit-side thickness d2. In the case of these thickness deviations δd2′, it is therefore necessary that the control device 9 determines the corresponding provisional thickness deviations δd2′ by means of the computing block 22 on the basis of the mass flow equation. Consequently, a respectively corresponding final entry-side thickness d1′ of the corresponding portion 12d is entered into the determination of the respective provisional thickness deviation δd2′. Furthermore, the entry speed v1 applicable to the respective portion 12d and the exit speed v2 applicable to the respective portion 12d are entered into the determination of the respective provisional thickness deviation δd2′. It is readily possible for the corresponding speeds v1, v2 to be known to the control device 9, since the portions 12d have already been rolled.

It is possible that the corresponding final entry-side thicknesses d1′ correspond directly to the thicknesses d1 detected for the portions 12d. It is similarly possible that the control device 9 determines—in each case for the respective portion 12d—the respective final entry-side thickness d1′ by a filtering of a number of thicknesses d1 detected on the entry side of the rolling stand 2. The determinations may take place in the same manner as explained above for the mass flow control (MFC).

In principle, the same procedure may be followed for the provisional thickness deviations δd2′ of the portions 12e. In this case, there is possibly no need for the computing block 24. However, for the provisional thickness deviations δd2′ of the portions 12e there is already a measured value for the exit-side thickness d2. In the case of these provisional thickness deviations δd2′, it is therefore possible that the control device 9 uses the respectively detected measured value for the determination of the corresponding provisional thickness deviations δd2′ . In particular, all that is necessary is to form the difference between the respective measured value d2 and the exit-side setpoint thickness d2* in the same block 24.

As far as the determination of its provisional thickness deviation δd2 is concerned, the portion 12c may be treated, according to requirements, like one of the portions 12d or like one of the portions 12e, the latter being preferred.

FIG. 10 shows—again only for the adjustment of the rolling stand 2—an overall structure of the control device 9. According to FIG. 10, the control device comprises three main blocks 25 to 27. The main block 25 implements an FBC. The FBC may be formed in particular as explained above in conjunction with FIGS. 7 to 9, that is to say realize one of these configurations. The main block 26 implements an MFC. The MFC may be formed in particular as explained above in conjunction with FIGS. 5 and 6, that is to say realize one of these configurations. The main block 27 implements an FFC (=feed forward control). The FFC compensates for entry-side thickness errors. It may be formed in particular as explained in the already cited earlier European patent application 20184420.6 of Primetals Technologies Germany GmbH. However, other configurations of the FFC are also possible.

Each of the main blocks 25 to 27 determines a respective setpoint value. It is generally a respective additional setpoint value. The additional setpoint values may be added to one another and—to the extent necessary—to a base setpoint value at a corresponding node point 28. The output signal of the node point 28 serves as an input signal for the adjusting device 13 or its control (HGC).

As already mentioned, it is possible that the control device 9 determines a number of setpoint values s*, M2*, vU*, v3*, M3*, v4*, M4* for a number of final control elements 13, 14, 3, 4. In the case of a number of setpoint values s*, M2*, vU*, v3*, M3*, v4*, M4* for a number of final control elements 13, 14, 3, 4, it may be necessary to delay individual setpoint values s*, M2*, vU*, v3*, M3*, v4*, M4* in time, in order to ensure a synchronous reaction of the various final control elements 13, 14, 3, 4. This is known and familiar to those skilled in the art and can be readily implemented. It therefore does not have to be explained in detail.

The present invention has many advantages. In particular, an almost complete correction both of entry-side thickness deviations and of exit-side thickness deviations δd2 is obtained in an easy way. This applies most particularly when not just an MFC and/or an FBC are realized in a manner corresponding to the invention, but both an MFC and an FBC are realized in a manner corresponding to the invention and furthermore an FFC is also additionally realized as explained in the European patent application 20184420.6. Furthermore, commissioning can be speeded up.

It is also readily possible to retrofit existing rolling mills in a manner according to the invention. This is so because the hardware as such, i.e. the rolling stand 2, the feeding device 3, the removing device 4, the measuring devices 5 to 8 and the control device 9, do not have to be modified. All that is necessary is for the control program 10 for the control device 9 to be modified.

Although the invention has been illustrated more specifically and described in detail by the preferred exemplary embodiment, the invention is not restricted by the examples disclosed and other variations may be derived therefrom by a person skilled in the art without departing from the scope of protection of the invention.

### LIST OF DESIGNATIONS

1 Metal strip
2 Rolling stand
3 Feeding device, final control element
4 Removing device, final control element
5 to 8 Measuring devices
9 Control device
10 Control program
11 Machine code
12 Portions of the metal strip
13 Adjusting device, final control element
14 Drive, final control element
15 Controller block
16 Modification block/inverse model
17, 18 Determination blocks
19 Transporting model
20, 21, 22, 24 Computing blocks
21, 23 Filter blocks
25 to 27 Main blocks
28 Node point
d1, d2 Detected thickness values
d1′, d2′ Final thickness values
S1 to S4 Steps
M2*, M3*, M4*, Setpoint values
vU*, v3*, v4*,
s*
s′* Provisional setpoint value
v1 to v4, vU Speeds/rates
Z Internal state
δd2, δd2′ Thickness deviations

1-13. (canceled)

14. An operating method for a rolling mill, comprising:
feeding, by a feeding device arranged upstream of a rolling stand of the rolling mill, a metal strip to the rolling stand;
rolling, by the rolling stand, the metal strip;
removing, by a removing device arranged downstream of the rolling stand, the metal strip;
determining cyclically, by a control device of the rolling mill, in each case based on a number of final thickness deviations of a corresponding number of portions of the metal strip from a setpoint thickness of the metal strip on an exit side in each case a number of setpoint values for a corresponding number of final control elements; and
outputting, by the control device, the determined setpoint values to the final control elements;
wherein the final control elements comprise at least one of:
the feeding device,
an adjusting device of the rolling stand for setting a rolling gap of the rolling stand,
a drive of the rolling stand for driving rolls of the rolling stand, and
the removing device,
wherein the setpoint value for the feeding device is one of a setpoint speed and a setpoint torque, the setpoint value for the adjusting device is a setpoint rolling-gap value, the setpoint value for the drive is one of a roll circumferential speed and a rolling torque, and the setpoint value for the removing device is one of a setpoint speed and a setpoint torque; and
wherein the control device determines at least one of the setpoint values based on the number of final thickness deviations with allowance for a description of the inverse frequency response of the respective final control element.

15. The operating method as claimed in claim 14, wherein the number of final thickness deviations of the respective cycle is equal to 1, in that the control device determines the final thickness deviation on the basis of a final entry-side thickness of the portion of the metal strip with allowance for an entry speed, at which the portion of the metal strip enters the rolling stand, and an exit speed, at which the portion of the metal strip exits the rolling stand, on the basis of the mass flow equation and in that the portion of the metal strip to which the determined final thickness deviation relates is the portion of the metal strip that is being rolled at that moment.

16. The operating method as claimed in claim 15, wherein the final entry-side thickness of the portion of the metal strip is a thickness of the portion of the metal strip that is detected on the entry side of the rolling stand before the respective cycle for the portion of the metal strip being rolled at that moment or in that the control device determines the final entry-side thickness of the portion of the metal strip by a filtering of thicknesses detected on the entry side of the rolling stand for a plurality of portions of the metal strip.

17. The operating method as claimed in claim 14, wherein the number of final thickness deviations of the respective cycle is equal to 1 and in that the final thickness deviation relates to a portion of the metal strip rolled before the portion of the metal strip being rolled at that moment.

18. The operating method as claimed in claim 17, wherein a measuring device, arranged between the rolling stand and the removing device, detects the exit-side thickness of the portion of the metal strip and feeds it to the control device and in that the final thickness deviation is determined on the basis of the detected exit-side thickness and the exit-side setpoint thickness.

19. The operating method as claimed in claim 17, wherein the control device determines the final thickness deviation by a filtering of a plurality of provisional thickness deviations of a corresponding number of portions of the metal strip from the exit-side setpoint thickness.

20. The operating method as claimed in claim 19, wherein the filtering is a zero-phase filtering, in that a first part of the provisional thickness deviations relates to portions of the metal strip which, although already rolled, were rolled after the portion of the metal strip to which the final thickness deviation relates, and in that the control device determines these provisional thickness deviations on the basis of a respective corresponding final entry-side thickness of the metal strip with allowance for an entry speed, at which the respective portion of the metal strip enters the rolling stand, and an exit speed, at which the respective portion of the metal strip exits the rolling stand, on the basis of the mass flow equation.

21. The operating method as claimed in claim 20, wherein, for the first part of the provisional thickness deviations, the respective final entry-side thickness of the portion of the metal strip is a thickness of the respective portion of the metal strip that is detected on the entry side of the rolling stand for the respective portion of the metal strip or in that the control device determines the respective final entry-side thickness of the respective portion of the metal strip by a filtering of thicknesses detected on the entry side of the rolling stand for a plurality of respective portions of the metal strip.

22. The operating method as claimed in claim 20, wherein a measuring device, arranged between the rolling stand and the removing device, detects the exit-side thickness in each case for portions of the metal strip and feeds it to the control device, in that a second part of the provisional thickness deviations relates to portions of the metal strip that were rolled before the portion of the metal strip to which the final thickness deviation relates, and in that, for the second part of the provisional thickness deviations, the control device determines the respective provisional thickness deviation on the basis of the respectively detected exit-side thickness and the exit-side setpoint thickness.

23. The operating method as claimed in claim 14, wherein:
the description of the inverse frequency response of the respective final control element of the control device is specified by a respective inverse model;
the control device feeds the final thickness deviation of a portion of the metal strip to the respective inverse model; and
the control device using the fed final thickness deviation by means of the respective inverse model correctively adjusts a respective internal state of the respective inverse model and determines the respective setpoint value.

24. A control program comprising machine code executable by a control device for a rolling mill, the execution of the machine code by the control device causing the control device to operate the rolling mill according to the operating method as claimed in claim 14.

25. A control device for a rolling mill, wherein the control device is programmed with the control program as claimed in claim 24, so that the control device operates the rolling mill according to the operating method.

26. A rolling mill for rolling a metal strip, comprising:
at least one rolling stand adapted to roll the metal strip;
a feeding device arranged upstream of the rolling stand, the feeding device adapted to feed the metal strip to the rolling stand;
a removing device arranged downstream of the rolling stand, the removing device adapted to remove the metal strip from the rolling stand; and
a control device adapted to operate the rolling mill according to the operating method as claimed in claim 14.
